(19) United States
(12) Patent Application Publication
(10) Pub. No.: US 2026/0117855 A1
(43) Pub. Date: Apr. 30, 2026

(54) GEAR TRANSMISSION DEVICE

(71) Applicant: Deere & Company, Moline, IL (US)

(72) Inventors: JORGE MORENO FLOREZ, MADRID (ES); DANIEL VERGARA MARTINEZ, MADRID (ES); MONICA GIL MARTINEZ, MADRID (ES); JAVIER JOSE PEREZ RAMIREZ, MADRID (ES)

(21) Appl. No.: 19/352,740

(22) Filed: Oct. 8, 2025

(30) Foreign Application Priority Data
Oct. 29, 2024 (EP) 24209565.1

(51) Int. Cl. F16H 57/04; F16H 1/20; F16H 57/021

(52) U.S. Cl. CPC F16H 57/0421; F16H 1/20; F16H 57/021; F16H 57/0471; F16H 57/0495; F16H 57/0457

(57) ABSTRACT

A gear transmission device comprises a gear housing surrounding a gear space, a drive shaft arranged in the gear space and having a drive tooth arrangement, an intermediate shaft arranged in the gear space and having a first and a second intermediate tooth arrangements, and an output shaft arranged in the gear space and having an output tooth arrangement. A portion of the gear housing forms a hollow space, which is substantially separated from the gear space connected to the gear space via an opening orientated counter to a rotation direction of the drive and output tooth arrangements. A collection hopper is arranged below the hollow space. The hollow space includes at least one discharge channel which leads into the gear space to the collection hopper. The collection hopper has a drain, which leads into a region of the shaft bearing.

### CROSS-REFERENCE TO RELATED APPLICATIONS

This application claims priority to European Patent Application No. 24209565.1, filed Oct. 29, 2024, which is hereby incorporated by reference.

### TECHNICAL FIELD

The present disclosure relates generally to a gear transmission device.

### BACKGROUND

A great variety of gear transmission devices are known in prior art. The most commonplace gear transmission devices include, for example, intermediate gear transmissions of the above-mentioned type. In this instance, a driving toothed wheel is brought into engagement at the input side with an intermediate gear transmission and the gear transmission is brought into engagement at the output side with an output toothed wheel. The drive toothed wheel and the output toothed wheel are in each case supported on individual shafts, wherein the intermediate gear transmission has a common intermediate shaft. In order to achieve a compact and space-saving structure, the two shafts of the drive and output toothed wheels are often supported in a state nested inside each other so that, for example, a shaft bearing of the drive shaft is arranged in a hollow shaft portion of the output shaft and in the form of an internal rolling bearing, for example a roller bearing or also a needle bearing. With such arrangements and configurations, as a result of high relative speeds between the drive shaft and output shaft an adequate lubrication of the internal rolling bearing must be ensured, particularly since a lubricant supply to the rolling bearing as a result of the internal arrangement is in any case possible only in a limited manner. As a result of the rotation of the drive and output wheels and the intermediate gear transmission, the gear oil, which is provided for lubrication and cooling, is primarily conveyed radially outward and under some circumstances reaches the region of the rolling bearing only in an inadequate manner. In order to nonetheless ensure adequate lubrication, lubricant holes, which extend in the drive or output shaft and lead from outer lubricant openings at the shaft ends up to the rolling bearing region, are generally provided. Via the lubricant openings, the rolling bearing region can then be supplied with lubricant by lubricant being introduced under pressure into the lubricant holes and directed into the rolling bearing region.

It is problematic or disadvantageous that such devices for lubricating the rolling bearing are complex in terms of production and the lubrication operations have to be carried out regularly or also permanently during operation.

### SUMMARY

The object on which the disclosure is to provide a gear transmission device that solves the aforementioned problems.

The object is achieved according to the disclosure by the teaching of one or more embodiments disclosed herein. Further advantageous embodiments and developments of the disclosure can be found in the one or more embodiments disclosed herein.

According to the disclosure, a gear transmission device of the type mentioned in the introduction is configured in such a manner that in a portion, which is arranged above the output shaft, of the gear housing there is formed a hollow space which is substantially separated from the gear space and which is connected to the gear space via an opening, wherein a collection hopper is arranged below the hollow space, wherein the hollow space further comprises at least one discharge channel which leads into the gear space to the collection hopper and wherein the connection hopper has a drain which leads into a region of the shaft bearing. The opening of the hollow space is orientated counter to the rotation direction of the drive and output tooth arrangement in such a manner that gear oil which is stirred up by the drive and output tooth arrangement is directed or transported into or reaches the opening. As a result of the drive and output tooth arrangement, which is circulating in the gear transmission device, the gear oil, with which the gear transmission device is filled for lubrication and cooling during operation, is stirred up and distributed in the gear space. In this instance, the gear oil is in particular distributed in the rotation direction of the drive and output tooth arrangement and in this manner also necessarily reaches the region of the opening. There, it flows via it into the hollow space formed in the gear housing and separated from the gear space. The gear oil which is directed therein accumulates in the hollow space and fills it. Via one or more discharge channels, the gear oil can flow out of the hollow space and be guided through the channel or channels selectively into the collection hopper. The collection hopper shields the accumulated gear oil from the gear oil which is stirred up in the gear space so that the gear oil which accumulates in the collection hopper is transported or directed in an unimpeded manner and selectively through the hopper outlet into the region of the shaft bearing. One or more lubrication hole(s) which are constructed in a conventional manner in the drive or output shaft for selective lubrication of a shaft bearing are consequently superfluous.

At least a first discharge channel which leads into the gear space to the collection hopper may comprise an outlet, which is orientated toward a hopper opening, which is open toward the gear space and faces the hollow space, of the collection hopper. The gear oil which is stirred up by the drive or output shaft reaches the hollow space via the opening of the hollow space and flows via the first discharge channel out of the hollow space. The output of the first discharge channel is arranged directly above the hopper opening so that gear oil flowing out of the hollow space flows as a result of gravitational force from above into the hopper opening and accumulates in the collection hopper, where it is shielded by the hopper wall from the turbulent gear oil in the gear space. From there, the gear oil which is supplied to the collection hopper reaches in an unimpeded and selective manner via the drain of the collection hopper the region of the shaft bearing.

The hollow space may comprise a second discharge channel which leads into the gear space to the collection hopper and which opens therein via a side wall of the collection hopper. Gear oil which accumulates in the hollow space can flow away via the second discharge channel in an unimpeded manner and directly into a lateral region of the collection hopper and can also accumulate in the collection hopper or fill the collection hopper. The gear oil is also in this instance shielded by the hopper wall from the turbulent gear oil in the gear space and reaches in an unimpeded and selective manner via the drain of the collection hopper the region of the shaft bearing. Other discharge channels which extend into other regions or other side walls of the collection hopper and contribute to filling the collection hopper with gear oil discharged from the hollow space may be provided.

The shaft bearing may be in the form of a space-saving and compact needle bearing which can be subjected to high speeds and is lubricated in a reliable and low-maintenance manner by the selective lubrication via the drain of the collection hopper. Other shaft bearings are also conceivable, for example roller bearings or ball bearings.

The gear transmission device described above is configured for relatively high output speeds, as a result of the fact that the drive tooth arrangement with the first intermediate tooth arrangement and/or the second intermediate tooth arrangement with the output tooth arrangement represents a transmission stage with a transmission ratio less than 1. The output speeds of the output tooth arrangement are consequently a multiple of the input speeds of the drive tooth arrangement. As a result of the above-described arrangement of the hollow space and the connected collection container for lubricating and cooling the shaft bearing which is subjected to high speeds, such gear transmission devices can be operated reliably with a minimized maintenance complexity. Complex lubricant holes (lubricant channels) formed in the drive axles are superfluous. Nonetheless, the gear transmission device may also be configured in such a manner that the drive tooth arrangement with the first intermediate tooth arrangement and/or the second intermediate tooth arrangement with the output tooth arrangement has a transmission stage with a transmission ratio greater than 1 so that the output speeds of the output tooth arrangement may consequently also be a multiple less than the input speeds of the drive tooth arrangement.

Other features and aspects will become apparent by consideration of the detailed description, claims, and accompanying drawings.

### BRIEF DESCRIPTION OF THE DRAWINGS

The disclosure and further advantages and advantageous further developments and embodiments of the disclosure will be described and explained in more detail below with reference to the drawings, which show an example embodiment of the disclosure.

FIG. 1 shows a perspective side view of a gear transmission device.

FIG. 2 shows a first cross-sectional view of the gear transmission device from FIG. 1.

FIG. 3 shows a second cross-sectional view of the gear transmission device from FIG. 1.

FIG. 4 shows a third cross-sectional view of the gear transmission device from FIG. 1 along a plane of section A-A illustrated in FIGS. 2 and 3.

FIG. 5 shows a first perspective side view of a shaft and tooth arrangement device of the gear transmission device from FIG. 1.

FIG. 6 shows a second perspective side view of the shaft and tooth arrangement device of the gear transmission device from FIG. 1.

FIG. 7 shows a first perspective side view of a collection container arranged in the gear transmission device from FIG. 1.

FIG. 8 shows a second perspective side view of the collection container arranged in the gear transmission device from FIG. 1.

Like reference numerals are used to indicate like elements throughout the several figures.

### DETAILED DESCRIPTION

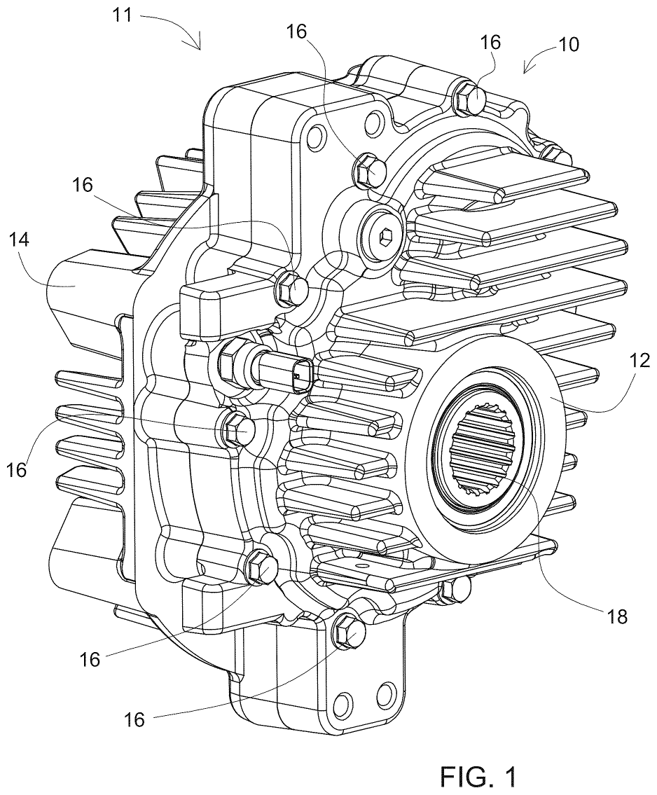

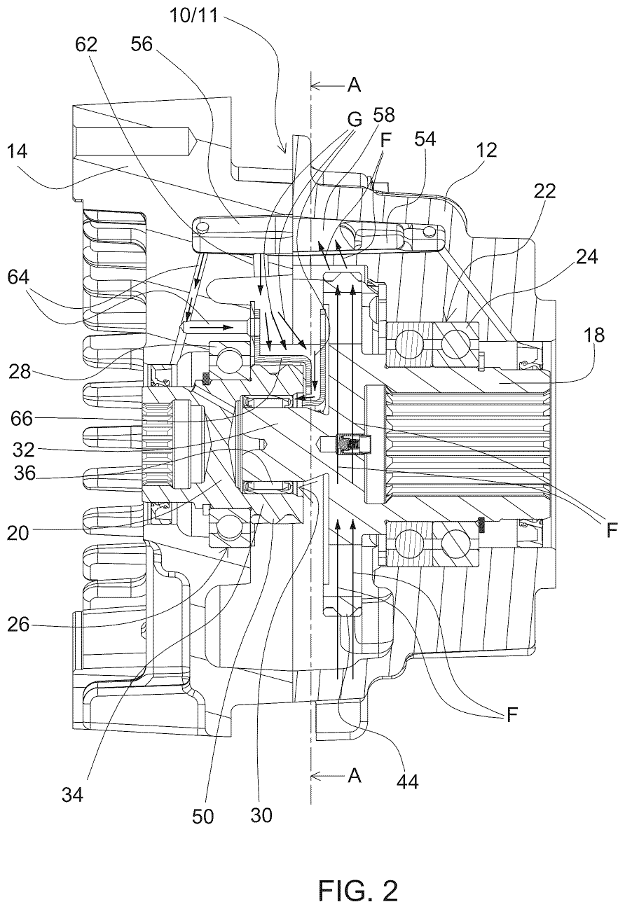

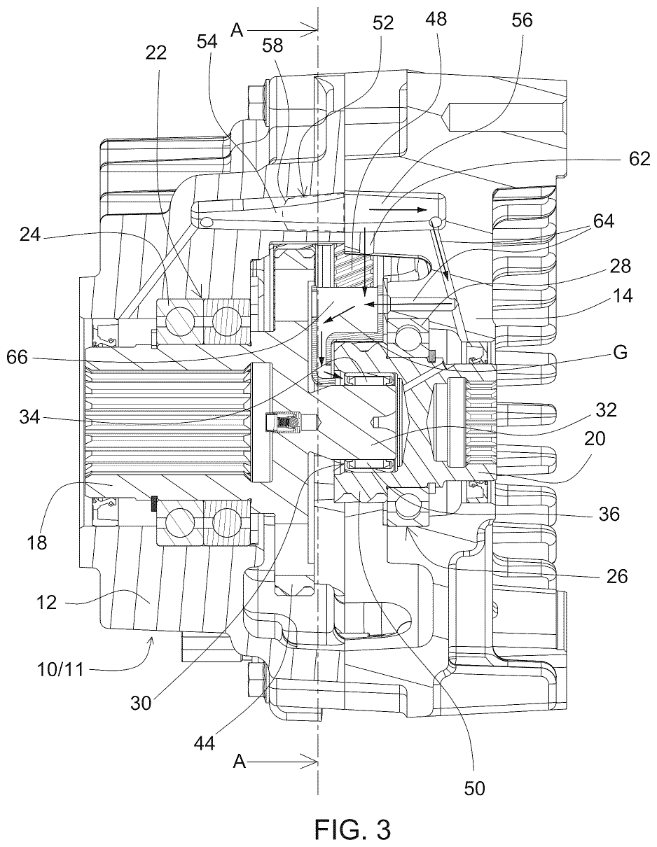

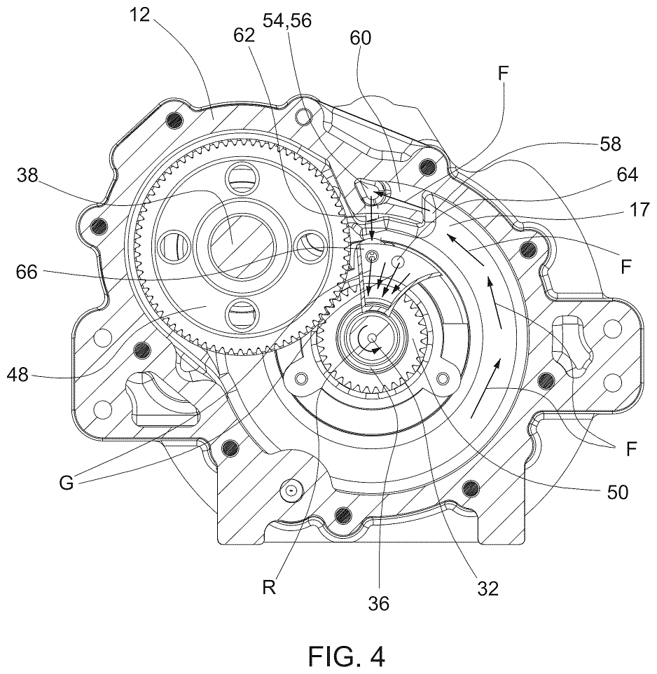

A gear transmission device 10 illustrated in FIG. 1 comprises a gear housing 11, which includes a first and a second gear housing portion 12, 14. The gear housing portions 12, 14 are joined by a plurality of gear housing bolts 16 and surround a gear space 17, as can be seen in FIG. 4. A drive shaft 18 is supported in the first gear housing portion 12 and an output shaft 20 is supported in the second gear housing portion. The bearing of the drive and output shafts 18, 20 can be seen in detail in FIGS. 2 and 3. The drive shaft 18 is supported at a first drive-shaft-side bearing location 22 by a dual ball bearing 24 in the first gear housing portion 12. The output shaft 20 is supported at a first output-shaft-side bearing location 26 by a single ball bearing 28 in the second gear housing portion 14. The drive shaft 18 and the output shaft 20 further share a common bearing location 30 which is in the form of a needle bearing 36 at the respective shaft ends 32, 34, which are arranged axially at the inner side of the gear transmission device 10, of the drive shaft 18 and the output shaft 20, wherein the needle bearing 36 receives the drive shaft 18 radially at the inner side and the output shaft 20 radially at the outer side.

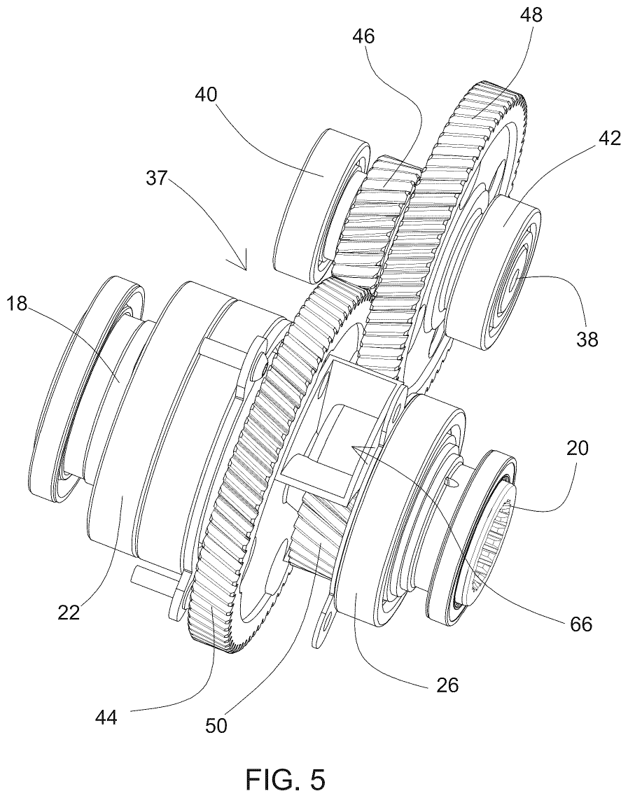

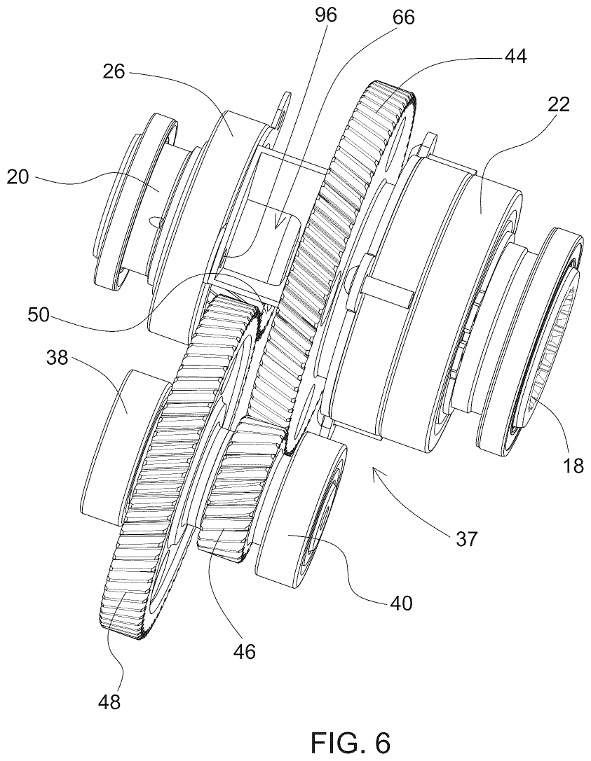

As shown in detail in FIGS. 5 and 6, the gear transmission device 10 comprises a shaft and tooth arrangement device 37. The shaft and tooth arrangement device 37 comprises an intermediate shaft 38 which is supported at a first bearing location 40 in the first gear housing portion 12 and at a bearing location 42 in the second housing portion 14. Furthermore, the shaft and tooth arrangement device 37 has a drive tooth arrangement 44 which is formed on the drive shaft 18 and a first intermediate tooth arrangement 46 which is formed on the intermediate shaft 38, wherein the drive tooth arrangement 44 is in engagement with the first intermediate tooth arrangement 46. Furthermore, the shaft and tooth arrangement device 37 comprises a second intermediate tooth arrangement 48 which is formed on the intermediate shaft 38 and which is connected to the first intermediate tooth arrangement 46 in a rotationally secure manner and an output tooth arrangement 50 which is formed on the output shaft 20 and which is in engagement with the second intermediate tooth arrangement 48. The drive tooth arrangement 44 has a larger diameter than the first intermediate tooth arrangement 46. The second intermediate tooth arrangement 48 has a larger diameter than the first intermediate tooth arrangement 46. In addition, the second intermediate tooth arrangement has a larger diameter than the output tooth arrangement 50. Consequently, starting from the drive shaft 18 to the output shaft 20, a transmission ratio of less than 1 is formed, whereby the output speeds of the output tooth arrangement 50 assume a multiple of the input speeds of the drive tooth arrangement 44.

As can be seen in FIG. 4, the drive tooth arrangement 44, the first intermediate tooth arrangement 46, the second intermediate tooth arrangement 48 and the output tooth arrangement 50 are arranged in the common gear space 17, wherein with respect to the gear space 17 the intermediate shaft 38 is arranged above the drive and output shafts 18, 20.

As can be seen in FIGS. 2, 3 and 4, in the gear housing 11 above the drive and output shafts a hollow space 52 is formed, wherein a first hollow space portion 54 is formed in the first gear housing portion 12 and a second hollow space portion 56 is formed in the second gear housing portion 14. The cross section of the gear transmission device 10 as shown in FIG. 4 shows a view along a plane of section A-A which is illustrated in FIGS. 2 and 3 and which is located in the region of the first gear housing portion 12 and enables a view of the second intermediate tooth arrangement 48 and the output tooth arrangement 50. As FIG. 4 shows, an opening 58, facing the gear space 17, of a channel 60 which leads into the hollow space 52 is formed above the output tooth arrangement 50. The opening 58 can also be seen in FIG. 2 and in FIG. 3 (in dashed form in the latter). The opening 58 is orientated counter to a rotation direction R of the drive and output tooth arrangement 44, 50. Gear oil which is located in the gear space 17 is stirred up by the drive tooth arrangement 44 and transported or moved in the direction of the opening 58. In this manner, the gear oil can be directed or transported or cleaned out of the gear space 17, through the opening 58 into the channel 60 and through the channel into the hollow space 52, as the arrows F illustrated in FIGS. 2 and 4 indicate. In the hollow space 52, gear oil can accumulate in a manner shielded from the gear space 17. As can also be seen in FIGS. 2, 3 and 4, starting from the hollow space 52 in the second hollow space portion 56 a first and second discharge channel 62, 64 which lead into the gear space 17 are formed.

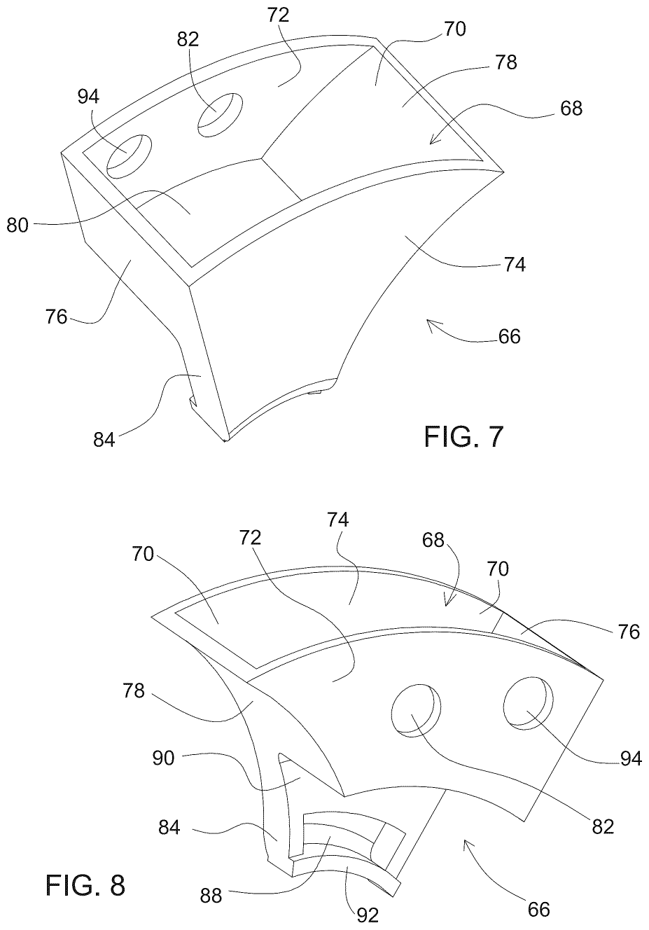

As can be seen in FIGS. 2-6, above the output tooth arrangement 50, between the drive tooth arrangement 44 and the output-shaft-side bearing location 26, a collection hopper 66 is arranged. The collection hopper 66 is illustrated in detail in FIGS. 7 and 8 and has a hopper-like connection region 68 with a hopper opening 70 which is orientated in the direction toward the hollow space 52. Furthermore, the collection region 68 is formed by four side walls 72, 74, 76, 78 and a base 80 which shield the collection region 68 with respect to the gear space 17, wherein a first side wall 72 adjoins the bearing location 26, an opposing second side wall 74 adjoins the drive tooth arrangement 44 and a third side wall 76 adjoins the second intermediate tooth arrangement 48. A fourth side wall 78 separates the collection region in the direction of the open gear space 17.

The first discharge channel 62 opens in the gear space 17 directly above the hopper opening 70 of the collection hopper 66 so that gear oil flowing out of the hollow space 52 is directed as a result of gravitational force into the collection hopper 66. The second discharge channel 64 opens in the gear space 17 at the side of the collection hopper 66 and directs an additional quantity of the gear oil flowing out of the hollow space 52 into a supply opening 82 which is provided in the collection hopper 66 in the first side wall 72. The two discharge channels 62, 64 described here both serve at the same time to discharge gear oil from the hollow space 52 into the collection hopper 66. It should be noted that, in another implementation, only one of the discharge channels 62, 64 which provides a discharge of gear oil from the hollow space 52 into the collection hopper 66 may also be provided.

The collection hopper 66 further has a drain 84 which is formed on the base 80 of the collection region 68. The drain 84 leads from a discharge inlet opening 86 which adjoins the base 80 of the collection region 68 in a radial direction along an intermediate space between the drive tooth arrangement 44 and the output tooth arrangement 50 and opens with a discharge outlet opening 88 at the common bearing location 30. The drain 84 is formed by lower regions of the second, third and fourth side wall 74, 76, 78, by a fifth side wall 90 which adjoins the output tooth arrangement 50 and by a discharge base 92, wherein the discharge outlet opening 88 is formed in the fifth side wall 90 adjacent to the discharge base 92. The gear oil directed from the discharge channels 62, 64 into the collection hopper 66 accumulates in the collection hopper 66 and flows away as a result of gravitational force via the drain 82 directly into the region of the common bearing location 30 or is discharged at that location.

In the first side wall 72 there is additionally provided a securing hole 94 by which the collection hopper 66 is secured via a securing screw 96 to the bearing location 26.

The above-described gear transmission device 10 is characterized in that gear oil is selectively supplied to the common shaft bearing, which is subjected to high speeds, of the drive and output shaft 18, 20 (see arrows F and G), wherein gear oil in the gear space 17 is stirred up by the drive tooth arrangement 18 and transported in the direction of the opening 58 to the hollow space 58 (see arrows F in FIGS. 2 and 4). From there, it reaches via one or more discharge channels 62, 64 (in this specific case, they are a first discharge channel 62 and a second discharge channel 64) the collection hopper 66 in which it can accumulate in a state shielded from the gear space and is directed via the drain 84 selectively into the region of the bearing location 30 to the common shaft bearing (see arrows G in FIGS. 2, 3 and 4).

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A gear transmission device, comprising:
a gear housing surrounding a gear space,
a drive shaft arranged in the gear space and having a drive tooth arrangement,
an intermediate shaft arranged in the gear space and having a first and a second intermediate tooth arrangements, and
an output shaft arranged in the gear space and having an output tooth arrangement,
wherein the drive tooth arrangement is in engagement with the first intermediate tooth arrangement, and the second intermediate tooth arrangement is in engagement with the output tooth arrangement,
wherein the drive shaft is supported in a shaft bearing, and the shaft bearing is arranged in the output shaft,
wherein in a portion, which is arranged above the output shaft, of the gear housing there is formed a hollow space substantially separated from the gear space and connected to the gear space via an opening, which is orientated counter to a rotation direction of the drive and output tooth arrangements,
wherein a collection hopper is arranged below the hollow space, the hollow space includes at least one discharge channel which leads into the gear space to the collection hopper, and the collection hopper has a drain, which leads into a region of the shaft bearing.

2. The gear transmission device of claim 1, wherein the hollow space includes a first discharge channel, which leads into the gear space to the collection hopper, and wherein an outlet of the first discharge channel is orientated toward a hopper opening, which is open toward the gear space and faces the hollow space, of the collection hopper.

3. The gear transmission device of claim 1, wherein the hollow space includes a second discharge channel, which leads into the gear space to the collection hopper, and the second discharge channel, via a side wall, of the collection hopper, opens therein.

4. The gear transmission device of claim 1, wherein the shaft bearing is a needle bearing.

5. The gear transmission device of claim 1, wherein the drive tooth arrangement with the first intermediate tooth arrangement or the second intermediate tooth arrangement with the output tooth arrangement represents a transmission stage with a transmission ratio less than 1.
